(19) United States
(12) Patent Application Publication
(10) Pub. No.: US 2012/0267187 A1
(43) Pub. Date: Oct. 25, 2012

(54) System for targeting directed acoustical energy

(76) Inventor: Curtis E. Graber, Woodburn, IN (US)

(21) Appl. No.: 13/066,697

(22) Filed: Apr. 21, 2011

(51) Int. Cl. G01S 3/80

(52) U.S. Cl. 181/125

(57) ABSTRACT

A system for targeting directed acoustic energy comprises a directed acoustic energy source. The system provides for locating a target relative to the location for the directed acoustic energy source and for aiming the directed acoustic energy source relative to the target to account for at least the effects of wind drift on the sound field generated by the directed energy source. Further sources of atmospheric data may include wind direction and speed and temperature, both at surface levels and at altitude and at a plurality of location including the locations of the target, the directed acoustic energy source and intermediate points.

### BACKGROUND

1. Technical Field

The field relates to sound projection and more particularly for targeting a relatively directional sound beam under variable atmospheric conditions.

2. Description of the Problem

The propagation of sound in the atmosphere relative to a fixed spatial reference often confounds expectations. Unlike light, which can almost always be treated in “line of sight” fashion over distances of a few kilometers, sound can propagate from point to point differently between day and night and depending upon wind conditions. This stems from the fact that sound propagates not just through air, but by means of the air. Atmospheric conditions contribute to changes in sound propagation paths in several ways.

Wind is one mechanism which alters the propagation of sound relative to two fixed points. The movement of the air relative to the fixed reference point shifts sound's direction of propagation in the plane of reference parallel to the ground. Being upwind from a sound source reduces the amount of sound energy received across level ground at a given distance due to refraction from shifts in the apparent speed of sound with increases in altitude and from the effective distance traveled by the sound increasing. Being downwind from a source can improve transmission of sound to a point at the same height across level terrain because the propagation speed of sound increases with altitude resulting in apparent downward refraction and because of the effective reduction in distance traveled by the sound. Low frequencies are less effected by cross winds than are higher frequencies on account of shifts in direction due to the wind. In addition, the propagation path can exhibit refraction effects due changes in the speed of sound at through in the medium. Refraction can direct sound upward away from the ground or downward into the ground in part based on differences in wind speed with changes in altitude. Wind speeds in a given direction usually increase with increases in altitude due to decreasing effects of ground friction with consequential changes in the refraction effects.

The speed of sound in air is also highly dependant on air temperature. Temperature changes through air are most usually associated with changes in altitude. Air temperature can vary substantially over the intended propagation path of a sound beam resulting in substantial refraction of sound. For example, during daylight, ground usually heats more quickly than water with the result that air close to the ground is hotter than air at elevation. Conversely, air just above a large body of water is cooler than air at increasing elevations over water. This arrangement often reverses at night. The lapse rate of air temperature over land with increasing altitude also depends upon the nature of ground and the character of any ground cover. Tarmac obviously warms more quickly and to a greater extent than does snow. Decreasing temperatures with altitude refracts sound upwardly while increasing temperatures with altitude refracts sound downwardly. This contributes (over land) to sound “traveling” better during the “still” of night than sound travels during daylight.

Other atmospheric conditions can be of consequence. Atmospheric humidity, increases of which reduce density altitude, can produce variation in the speed of sound resulting in refraction effects. Precipitation, smoke particles, dust or other atmospheric particulate content can absorb or reflect sound energy, though at low frequencies the length of sound waves relative to the size of the particles is so great that these issues can be ignored. Issues that arise are most commonly encountered occur with respect to snow which can absorb noticeable portions of the higher parts of the audio spectrum and can be of particular consequence with respect to an ultrasonic carrier beam modulated by a lower frequency sound wave.

Most research in the area of sound propagation in the atmosphere has dealt with omnidirectional sources. Less consideration has been given to the transmission to a target of a directed sound beam, particularly a sound beam meeting a desired energy spread and intensity over a frequency range. Precision sound targeting grows increasingly difficult as distances between the sound source and the target due to the quantity of and changing relationships between losses, air motion effects and refraction. Further complicating matters with respect to directed acoustic energy is the possibility of mounting the sound source on a moving platform that may be located at altitude. Another complication raised by transmission of a focused or collimated beam of sound (or more generally put, sound from a directed acoustic source) is that, notwithstanding focusing or collimating of the sound, different portions of the sound frequency spectrum will spread at different rates. The low frequency portion of the sound “beam” can be much broader than the high frequency portion of the sound due both to its being harder to collimate and due to its tendency to spread more quickly. As a result refraction of the sound beam or wind shear effects can have greater consequences for perceived intensity of the higher frequencies than its does for lower frequencies. Shifts of the beam center relative to a target result in a quicker drop off in high frequency energy reaching the target.

### SUMMARY

A system for targeting directed acoustic energy comprises a directed acoustic energy source. The system provides for locating a target relative to the location for the directed acoustic energy source and for aiming the directed acoustic energy source relative to the target to account for at least the effects of wind drift on the sound field generated by the directed energy source. Atmospheric data (or estimates) considered may include wind direction and speed as well as temperature. These may be considered both at the surface and at altitude as well as at a plurality of locations including the locations of the target, the directed acoustic energy source and intermediate points.

### BRIEF DESCRIPTION OF THE DRAWINGS

Understanding of the following description may be enhanced by reference to the accompanying drawings, wherein:

FIG. 1 is an illustration of a localized theater of operations for a sound field projection system.

FIG. 2 is a partial cutaway view of a broadband directed acoustic source with which the present invention may be practiced.

FIG. 3 is a block diagram of a control system.

FIG. 4 is a graphical depiction of data for estimating a wind shift and refraction of a sound field directed onto a target.

FIG. 5 is an alternative directed acoustic energy source.

FIG. 6 is a perspective view of a phased array directed sound source.

FIG. 7 is a simplified control system for the phases array directed sound source.

### DETAILED DESCRIPTION

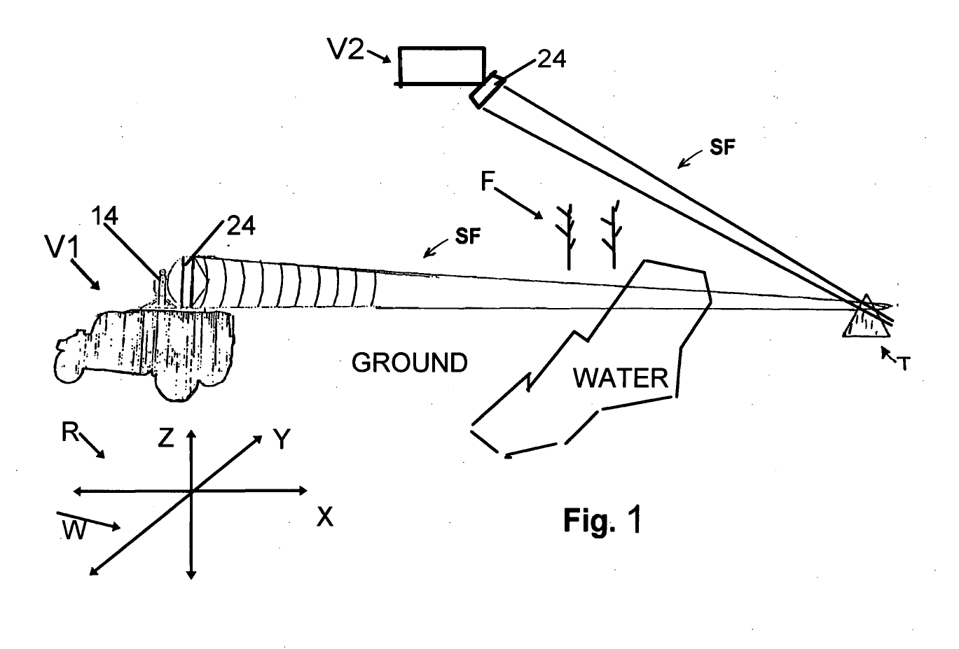

Referring to FIG. 1 an environment is illustrated in which various platforms/vehicles V1, V2, for supporting directed acoustic sources 12 are provided. Vehicle V1 may be taken as a surface vehicle, either a ground vehicle or a water craft. Vehicle V2 may be taken as an aircraft, either manned or unmanned. Directed acoustic sources 12 can be aimed so that a sound field SF impinges on target T with closer to a desired energy/frequency spread than can be achieved by line of sight targeting. Sound field SF is depicted as converging, however, it may be collimated or, less frequently, diverging. The degree of convergence, divergence, or collimation may vary as a function of frequency. A coordinated, but independently targeted optical device and/or electro/magnetic radiator 15 may be associated with the directed acoustic sources 12 as described below.

Sound propagates in the environment with reference to a spatial reference frame R which is geographically fixed. The coordinate axes X, Y and Z of spatial reference frame R are conventional with X and Y being normal to the direction of gravity and usually corresponding to magnetic N/S and E/W while Z corresponds to altitude. The environment is characterized in simplified fashion with areas of ground, water and woodland F. A target T is located within the environment. It is intended to direct sound energy in a sound field SF onto target T with selected frequencies meeting selecting intensity levels. The sound field SF is usually, though not necessarily, from a single source. Sound energy may originate from directed acoustic sources 12 carried by platforms, such as vehicles V1 or V2 which may include ground vehicles, ships or aircraft. Alternatively, the sound source may be at a fixed location in the environment in the X/Y plane.

Vehicles V1 and V2, and target T, are immersed in the transmission medium for sound, here the atmosphere. Wind W is treated as having a direction relative to the X, Y plane. Thermal and wind gradients can exist relative to the Z axis and can vary in the Z axis at various locations in the X, Y plane. For example, it may be daylight and a body of water W may separate Target T and vehicle V1. The directed sound source mounted on vehicle V1 is selected to generate the sound field SF to direct onto target T. The temperature gradient with increasing altitude may be negative over land, positive over water, and generally have a greater absolute magnitude over land than over water. Woodland F may change local wind direction. Directed acoustic source is to be aimed to minimize energy input while meeting target energy levels across the acoustic spectrum of the sound field which impinges on the target T.

As elaborated above, a number of factors contribute to refraction of the sound field between a directed acoustic source 12 and target T. Data of varying degrees of reliability relating to some or all of the factors may be available for aiming of the directed acoustic source 12. Data may be available for some or all of the following factors:

TABLE 1
Wind Speed (including wind speed at different altitudes)
Wind Direction (including wind direction at different altitudes)
Temperature (including temperature at different tempertures)
Humidity or Dew Point
Presence of liquid or solid matter suspended or falling through the air
Platform and target movement vectors
Platform altitude

The sources of data may be remote, local remote sensing, local or from weather reports. In addition, derived parameters may be developed from these inputs, for example density altitude. The source of data may effect its reliability, and if local, the data may be highly granular relative to the spatial reference frame R. Sensors located on one of vehicles V1 or V2 may used to determine temperature at the vehicle and to estimate temperatures along possible sound propagation paths to the target T, as well as to determine the range, bearing and acoustic bearing to the target T. Depending upon available data correction of targeting may be simple as solution of the wind drift from the platform to the target or may be more complex. Wind speed and direction will almost always be available, but may be derived from a raw wind velocity measurements taken on the platform corrected for platform velocity. Similarly local temperature should be available. The calculated acoustic bearing usually includes a vertical component (elevation), but this may depend upon available data and capabilities of the system. Power input may be varied by frequency range. Alternatively, or in supplement thereto, equalization of the sound beam based on calculated losses at given frequency ranges, for example due to atmospheric particulate content, may be calculated and the signal compensated therefor. Where the platform is a vehicle and mobile the system may take this factor into account and recommend to an operator relocation of the platform to achieve an acoustic bearing to the target or to achieve an acceptable signal. It is also possible to display to an operator the degree of degradation of the signal and allow the operator to decide on a mix of steps to take. Signal degradation may be characterized in various ways. For example, if it is human speech that it is to be transmitted an estimate of intelligibility may be given. Of course, various languages vary in their frequency content, particularly with regard to formation of consonants. For example, Arabic is dominated by relatively low and middle frequencies compared to a southern African click languages. As a consequence identical conditions can have differing effects on the intelligibility of a transmission depending upon which language it is in.

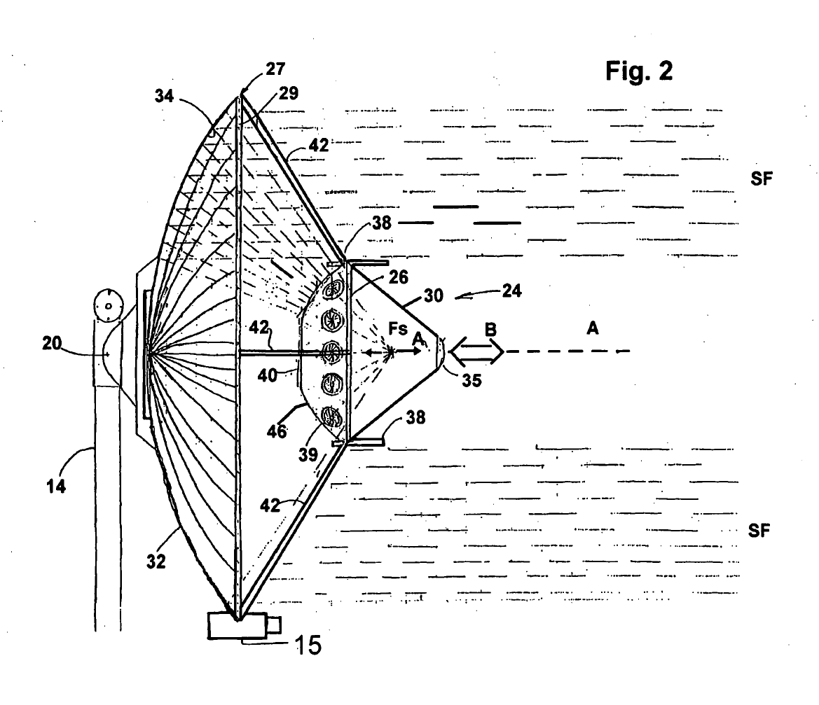

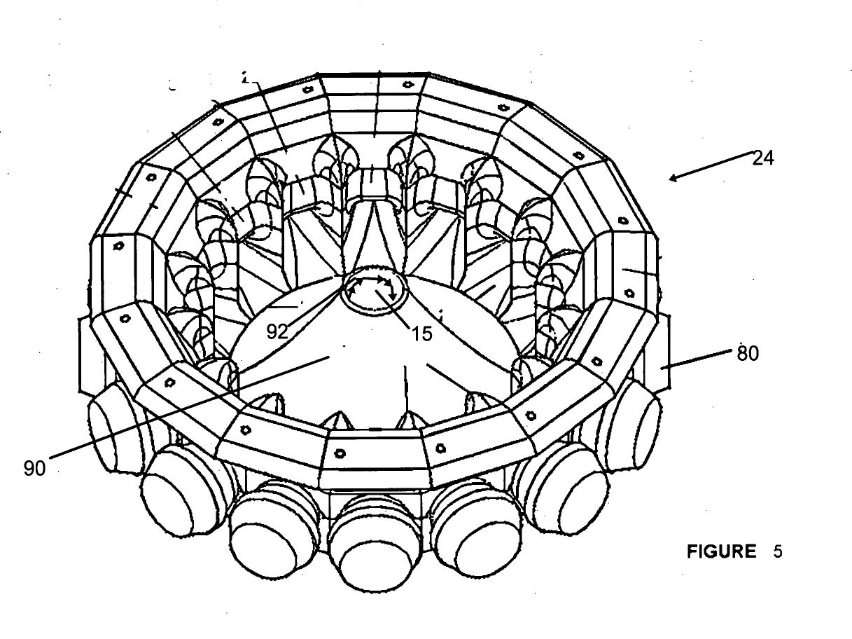

Referring to FIG. 2, a broadband directed acoustic source 24 as described in U.S. Pat. No. 7,912,234 and commonly owned with the present application is depicted. Directed acoustic source 24 is one type of acoustic source with which the presently disclosed methods and systems may be practiced. Its description here is intended only as an example of a broad band system and to illustrate these techniques. Alternative acoustic sources, for example the system of FIG. 5, use a single category of transducer for broadband sound generation.

Broadband directed acoustic source 24 is based on a primary parabolic reflector dish 32 having a front concave reflecting surface 34 with a forward radiant axis A. Forward concave reflecting surface 34 preferably has a parabolic contour. Sound is reflected forward from concave reflecting surface 34 in a sound field SF toward target T substantially forward from the reflecting surface. Sound field SF is fed by low frequency and high frequency acoustical transducers operatively positioned in a spaced relationship in front of the front concave reflecting surface 34 and centered on the forward radiant axis A. The acoustical transducers are mounted in the loudspeaker enclosure 30 and, more specifically, are mounted on a secondary parabolic ring 46 forming part of one end of enclosure 30 located closer to primary parabolic dish 32. More specifically, loudspeaker enclosure 30 lies acoustically forward from the concave reflecting surface 34, on the forward radiant axis A. Loudspeaker enclosure 30 includes the secondary parabolic ring 46 and a lens cap 35 defining an acoustic cavity. Low frequency sound is generated by a loudspeaker 40 which is centered on the forward acoustical axis A in the secondary parabolic ring 46 and oriented to direct sound into concave reflecting surface 34. The low frequency sound source is illustrated as a single driver; diaphragm unit, however multiple drivers could be used. Middle and high frequency sound is sourced from around the secondary parabolic ring by a plurality of horn loaded tweeters 39. The tweeters 39 are oriented outwardly from the forward radiant axis and into the outer portion of primary parabolic dish 32. Again, other high frequency sound services could be used, e.g. high frequency diaphragm elements. Tweeters 39 are arrayed radially around forward radiant axis A in a circle and the projection axis of the sound they generate is canted outwardly from the forward radiant axis A of the concave reflecting surface 34. Alternatively, the low frequency device could be a circular diaphragm disposed centered on the forward radiant axis with the HF sources located on or nearer to the forward radiant axis A.

Whatever the arrangement, sound from both sets of transducers is reflected forward from concave reflecting surface 34 in a sound field SF. Directed acoustic source 12 may be displaced from target T by several hundreds or thousands of meters.

Enclosure 30 provides both support for the transducers and a framework 27 for moving the transducers in and out along forward projection axis A relative to concave reflecting surface 34 allowing sound field SF to be made converging, diverging or collimated. By moving enclosure 30 the far focus of converging forward reflected sound waves can be changed from tens of meters to hundreds of meters. Enclosure 30 is supported forward from concave reflecting dish 34 on framework 27 which is mounted to a rim 29 set on the perimeter of primary parabolic dish 32. The framework includes a plurality of struts 42 extending from the rim 29 forward from concave reflecting dish 34. Struts 42 converge on a perimeter ring 26 of smaller diameter than rim 27. Enclosure 30 rides on tracks 38 supported by the perimeter ring 26. Tracks 38 lie parallel to the forward radiant axis A. Linear motors (not shown) may be used to lock enclosure 30 in place on the tracks 38 and to move the enclosure to and fro along the forward radiant axis A as indicated by double arrow B. Movement of enclosure 30 changes the location of apparent source of sound directed into the concave reflecting dish and also changes the point of convergence of sound field SF forward from the concave reflecting surface 34.

Conveniently mounted somewhere on the framework 27, such as depending from rim 29, is an optical or electromagnetic device 15. This may a range finder and include a television camera and laser range finder. Optical device 15 may also advantageously be mounted in lens cap 35 and nominally aligned with the forward radiant axis A of the concave reflecting surface 34.

Acoustic projector 24 is movable as a unit up and down and in a circle using a motorized altazimuth mounting 20 set on the upper end of mast 14. Optical device 15 is similarly mounted for two axis movement relative to acoustic projector 24, though it defaults to alignment on an axis parallel to, or bore cited with, the acoustic projection (forward radiant) axis A. Where the acoustic projector 24 is installed on an aircraft, mast 14 is not typically used. In some circumstances an optical device 15 and acoustic source 24 may be located on different platforms, but operated in a coordinated fashion.

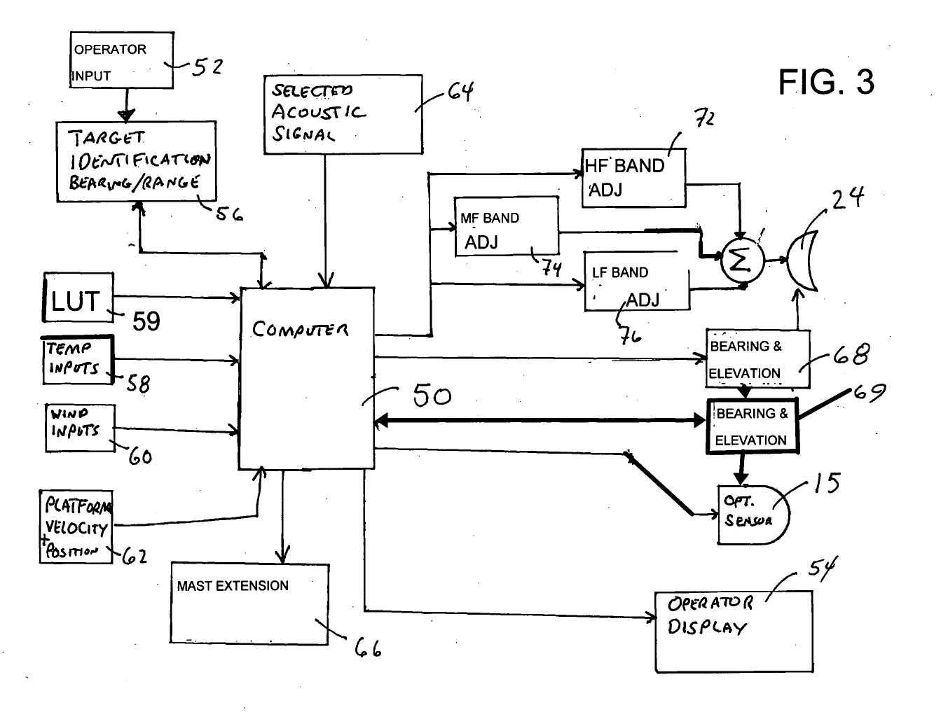

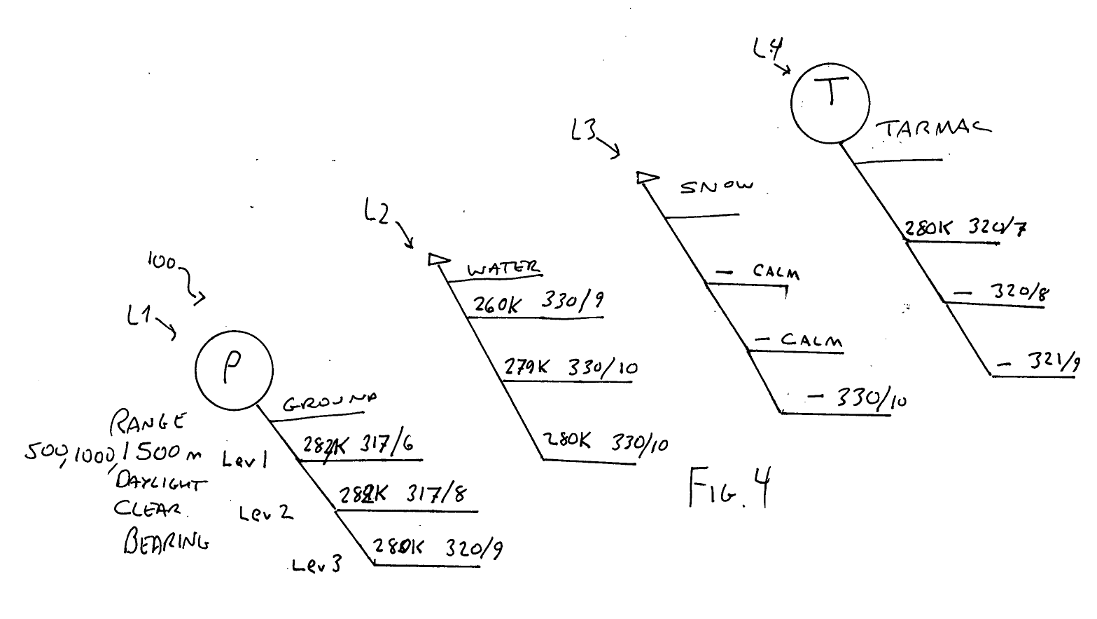

Referring to FIG. 3 a control arrangement for directed acoustic source 24 and optical device 15 is illustrated. Computer 50 should be taken in a broad sense as including both remote and local elements which communicate with one another using secure telematics links. Computer 50 is usually to be taken in a collective sense as data processing and control facilities associated with a platform such as vehicle V1 or vehicle V2 and its directed acoustic source 24. Computer 50 may be connected to a variety of data inputs, which are conflated functionally here in the sense of a temperature input 58 and a wind input 60. The actual source of these inputs may be a remote weather station or weather monitoring equipment such as a drone located in the same theater of operations of the platform in which the directed acoustic source is operating. In some cases the source of the data may be local such as a temperature sensor installed on the platform and/or an infra-red sensor located on the platform. If there are particulates suspended or falling through the air a local doppler radar may provide remote wind speed information between the platform and a target T. In such cases there can be some granularity to the wind and temperature data between the platform and the target T (see FIG. 4) in the sense that computer 50 may have wind and temperature data for a plurality of locations and for several altitudes at some or all of the locations.

There exist additional inputs to targeting computer 50. An operator, likely with reference to operator display 54, identifies the target T. Once a target is selected its bearing and range 56 from the platform may be determined. In addition, platform velocity (speed and direction) as well as position 62 may be continually fed to targeting computer 50. If the data is granular targeting computer 50 may calculate a refraction and wind shift profile for sound propagation from the platform to target T. If data is available only for the platform and is limited to wind velocity targeting computer may solve a simple wind triangle problem. The solution approach taken depends upon the data available, potentially the range to the target T and may be selected by the operator based on his or her judgement as to the reliability of the data.

It may be an objective to hit a target T with particular energy levels for given frequency bands/levels. This characterization is included in the data provided by the selected acoustic signal input 64. For convenience the acoustic spectrum may be divided into frequency bands including, by way of example: a low frequency band from 100 to 600 Hz; a middle frequency band from 600 Hz. to 1.5 kHz.; and a high frequency band above 1.5 kHz. Each frequency band may be independently adjusted (frequency band adjustment subsystems 72, 74 and 76) based on differing degrees of amplification or other equalization criteria before introduction to directed acoustic source 24. Where upward refraction or wind deflection of the sound field SF is indicated by the data high and middle frequency sound may be amplified to a greater extend than low frequency sound frequencies to compensate for the greater directivity of the sound field SF in higher frequency bands. In addition directed acoustic source may be raised by driving mast extension controller 66 to change the extension of mast 14 and thereby allow depression of the angle of the directed acoustic source through bearing and elevation controller 68 to allow compensation for upward refraction of sound due to decreasing temperature with upward changes in altitude or a headwind.

Optical device 15 is usually carried by directed acoustic source 24 but is independently steerable (using bearing and elevation controller 69) to allow optical device 15 to tract target T based on line of sight acquisition while directed acoustic source is diverted off the line of sight to adjust for drift and refraction of a sound field SF.

Optical device 15 may be considered as representing a conflation of possible devices including one or more of the following, a visual or thermal camera, a laser dazzler, a radar set, a search light, a microwave projector, etc.

FIG. 4 illustrates granularity of data along the line of sight from a platform at location L1 on which a directed acoustic source 24 is positioned and a target T at location L4. Some data are available at intermediary locations L2 and L3. As represented, a fairly complete set of data inputs is available at L1 including range to target T of 1500 meters during daylight with clear sky conditions. Wind direction, velocity and temperature data at three levels is available to some extent for four locations. At an intermediate location L2 wind direction, speed and temperature data are available at three levels. At intermediate location L3 wind data are available as they are at a target location along with a target temperature. In addition, a surface characterization is available such as “water,” “ground,” “snow,” or “tarmac.” The characterizations are given as examples only, and the list is not intended as limiting. Here it may be surmised that the platform P and target T are on open ground or tarmac while location L2 corresponds to a point over open water and location L3 is in an area shaded by trees. These factors may be used as points of reference for estimating the likely temperature gradient with altitude for an area. Additional terrain considerations can further complicate the calculations or correction factors may be accessed from a look up table (LUT) 59.

It is possible that no solution exists at a given location for directing an optimal or even acceptable sound field SF onto a target. In such cases instructions for relocation of the platform may be displayed to the operator or indication given the transmission may be compromised, as noted above.

FIG. 5 illustrates an alternative directed acoustic source 24 based on a central parabolic spike 90 with a camera 15 located in a central bore 92 of the parabolic spike and an array of loudspeakers 80 arrayed surrounding the spike and directed into the spike for reflection forward. Parabolic spike 90 can include a plurality of scalloped regions. Loudspeakers 80 are broadband transducers unlike the system used in FIG. 2.

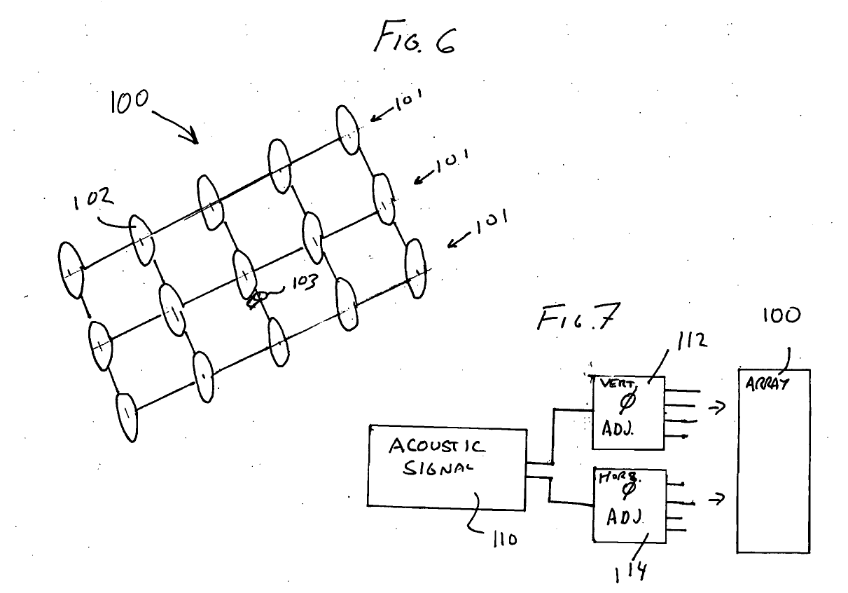

Directed acoustic beams can be generated in other ways than by use of various types of parabolic reflectors. Line arrays and phased arrays of a plurality of speakers are one alternative. In line arrays and phased arrays beams are produced by constructive and destructive interference patterns in sound fields produced by individual speakers. Control over the phase relationship between loudspeakers in a line array allows the beam to be steered in the plane of the line. FIG. 6 depicts a phased array 100 constructed from a plurality of loudspeakers 102. A phased array may be considered as a stack of horizontal line arrays 101. In a phased array the beam may be steered both in the horizontal plane and in the vertical plane. An optical device 103 may be associated with a phased array where the optical device is mounted for up/down and side-to-side movement. While the sound beam from phased array 100 may be steered the array itself can remain stationary. A highly simplified control arrangement for steering a beam from an array 100 is shown in FIG. 7 where the signal from a signal source 110 is modified for vertical adjustment 112 and horizontal adjustment 114 for each speaker in array.

A phased array 100 such as shown in FIG. 6 can of course be operated as a planar array by operating all of the loudspeakers in phase with one another (an “isophasic planar array”) or with the output of the loudspeakers having a fixed phase relationship with one another. The beam produced by a planar array can be steered by physically steering the array.

What is claimed is:

1. A system for targeting directed acoustic energy, comprising:
a directed acoustic energy source;
means for locating a target relative to the location for the directed acoustic energy source;
data inputs relating to atmospheric conditions; and
means for determining a targeting solution to the target.

2. A system for targeting directed acoustic energy as set forth in claim 1, further comprising:
the targeting solution including an acoustic bearing; and
means for adjusting aiming of the directed acoustic energy source on the acoustic bearing to compensate for wind drift or atmospheric refraction.

3. A system for targeting directed acoustic energy as set forth in claim 2, further comprising:
the data inputs including wind direction and speed and air temperature.

4. A system for targeting directed acoustic energy as set forth in claim 2, further comprising:
the data inputs including including wind direction, speed and temperature for a plurality of altitudes and locations between and including the location of the directed acoustic energy source and the target.

5. A system for targeting directed acoustic energy as set fort in claim 4, further comprising:
the directed acoustic energy source being steerable in two axes;
an optical or electro-magnetic device having a default orientation depending upon the orientation of the directed acoustic energy source; and
means for independently aiming the optical or electro-magnetic device.

6. A system for targeting directed acoustic energy as set forth in claim 5, further comprising:
a platform allowing selection of location for the directed acoustic energy source.

7. A system for targeting directed acoustic energy as set forth in claim 5, further comprising:
a mast for changing the altitude of the directed acoustic energy source.

8. A system for targeting directed acoustic energy as set forth in claim 6, further comprising:
means for indicating to an operator that the platform can be relocated to achieve an improved targeting solution or to indicate effects of implementing a locally optimized targeting solution.

9. A system for targeting directed acoustic energy as set forth in claim 6, further comprising:
a source specifying directed acoustic signal quality or intensity at the target;
frequency band amplifiers for operation to compensate for differential spread of a sound field over different frequency bands at a range to the target.

10. A system for targeting directed acoustic energy as set forth in claim 9, further comprising:
the directed acoustic signal being a broadband signal.

11. A system for targeting directed acoustic energy as set forth in claim 6, further comprising:
means for specifying terrain categories for each location.

12. An acoustic system comprising:
a directed acoustic source;
a target identification subsystem for determining a bearing and range to a target from the directed acoustic source;
sources of data relating to atmospheric conditions including at least wind speed and direction corresponding to the general location of the directed acoustic source or the target; and
a data processing subsystem for determining wind drift from the data and aiming the output of the directed acoustic energy source to compensate for the wind drift at the determined range and bearing.

13. An acoustic system as set forth in claim 12, further comprising:
the sources of data relating to atmospheric conditions further including temperature data corresponding to the general location of the directed acoustic source of the target; and
the data processing system further providing for determining acoustic refraction from the temperature data and the wind speed and direction data for correcting aiming of the directed acoustic source.

14. An acoustic system as set forth in claim 12, further comprising:
an optical or electro-magnetic system; and
the data processing system further providing for aiming the optical or electro-magnetic system at the target on a line of sight basis.

15. An acoustic system as set forth in claim 13, further comprising:
an optical or electro-magnetic system; and
the data processing system further providing for aiming the optical or electro-magnetic system at the target on a line of sight basis.

16. An acoustic system as set forth in claim 15, further comprising:
geographic data inputs relating to characterizations of terrain at locations between and including the locations of the target and the directed acoustic source;
meteorological inputs relating to particulate content in the atmosphere; and
the data processing system being responsive to the geographic data, the wind speed and direction data and the temperature data for generating a wind drift and refraction profile across the range from the directed acoustic source and the target and to the particulate content for estimating acoustic loss due to absorption and scatter.

17. An acoustic system as set forth in claim 15, further comprising:
bearing and elevation controls for the directed acoustic source.

18. An acoustic system as set forth in claim 17, further comprising:
means for controlling the height of the directed acoustic source.

19. An acoustic system as set forth in claim 16, further comprising:
the data processing system being further responsive to the estimated loss calculation for modifying the projected acoustic spectrum to enhance the intelligibility of language at the target.
